(19) United States
(12) Patent Application Publication
(10) Pub. No.: US 2007/0287035 A1
(43) Pub. Date: Dec. 13, 2007

(54) Attachable Battery For Attachment To Electrically Conductive Connector

(75) Inventors: George Marmaropoulos, Yorktown Heights, NY (US); Giang Vu, New York, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,981

(22) PCT Filed: Sep. 22, 2005
(86) PCT No.: PCT/IB05/53131

§ 371 Date: Mar. 26, 2007

Related U.S. Application Data
(60) Provisional application No. 60/614,001, filed on Sep. 28, 2004.

(51) Int. Cl. H01M 8/00

(52) U.S. Cl. 429/13; 429/34; 439/37

(57) ABSTRACT

Current batteries lack the requisite design, functionality, and user interface required by the fashion/garment industry. The invention proposes a battery, a battery housing, a wearable garment, and a method for supplying power, all of which involve a battery. The portable power source of the invention includes a fuel cell, or a battery, a positive terminal, a negative terminal, a housing, a mechanical resistance generator, at least one aperture for receiving at least one electrical connector, and a moveable portion coupled to the housing which the mechanical resistance generator presses against the at least one electrical connector against the positive terminal and the negative terminal to form a circuit.

Portable electronic devices such as MP3 players, camcorders, digital cameras, PDAs, laptop computers, and cellular telephones are becoming increasingly small and portable. The demand for increased portability and convenience drives a major trend in the consumer electronics marketplace toward wearable electronic devices that can be attached to garments. These “wearable electronic devices” require electrical connection both with other devices (i.e., headphones connected to an MP3 player) as well as with circuits that form part of a garment itself (i.e., conductive fibers, etc.). Wearable electronic devices also require mechanically strong connections because the electronic devices need to stay attached to a wearer's garment as the wearer moves (i.e., a portable MP3 player attached to a jogger's shorts). They also require innovative power cells and switches. Further, wearable electronic devices also demand a level of fashion and functionality (i.e., as garment closures) not generally associated with conventional electronic devices.

Currently, conventional batteries (for example, AA sized 1.5 volt AA alkaline cylindrical batteries with a positive terminal one end and a negative terminal on the other) or batteries designed for specific devices such as NiCd, NiMH, or Li Ion cellular phone batteries re used as power sources portable electronic devices. The term battery is herein defined as any portable power source. Batteries are usually contained in a housing within a portable electronic device. This often adds significantly to the weight of the portable device. Additionally, it can be cumbersome to replace the batteries, especially when the portable electronic device is integrated into a wearable garment. Further, different devices often require different shaped batteries (i.e., a cell phone may require a 6 volt NiMH battery shaped for the specific brand and model number phone, whereas an MP3 player takes standard AA 1.5 volt cylindrical batteries). Given the requisite power demands of these portable devices, it is difficult for a user to always carry replacement power sources, or stop for recharging, while in transit. Further, it is cumbersome to attach or remove prior art batteries for the frequent washing of a garment. Thus, current batteries lack the requisite design, functionality, and user interface required by the fashion/garment industry.

The invention solves at least these problems in at least one aspect where a battery includes a fuel cell, a positive terminal, a negative terminal, a housing, a mechanical resistance generator, at least one aperture for receiving at least one electrical connector, and a moveable portion coupled to the housing which the mechanical resistance generator presses against the at least one electrical connector against the positive terminal and the negative terminal to form a circuit.

In one embodiment, the mechanical resistance generator can be a spring, an elastic material, a pneumatic device, a screw, or a wedge. In another embodiment, the moveable portion can be a piston, a wheel, a button, or a screw.

In one embodiment, the battery includes a first aperture for receiving a first electrical connector and a second aperture for receiving a second electrical conductor, and the first aperture contains the positive terminal and the second aperture contains the negative terminal.

In another embodiment, the mechanical resistance generator presses a first moveable portion against an electrical conductor in the first aperture which forms an electrical connection with the positive terminal and a second moveable portion against a second electrical conductor in the second aperture which forms and electrical connection with the negative terminal to form a circuit.

In one embodiment, the at least one electrical conductor further is an electrically conductive cord.

In another embodiment, the mechanical resistance generator provides sufficient frictional force by pressing the moveable portion against the electrically conductive cord to overcome the force of gravity such that the electrically conductive cord will support the weight of the battery.

In another embodiment, the moveable portion can be moved such that position of the battery along the electrically conductive cord may be altered.

In one embodiment, the electrically conducive cord is an insulated conductive fabric cord. In another embodiment, the at least one electrical connector electrically connected to an electrical device.

In one embodiment, the at least one electrical connector includes at least two portions which can be individually pressed against the positive and negative terminals by the mechanical resistance generator to form at least two circuits.

In one embodiment, an electrical connection between the electrical device and the battery passes through a wearable device.

In one embodiment, the at least one aperture includes both the positive terminal and the negative terminal and a first portion of the at least one electrical connector contacts the positive terminal and a second portion of the at least one electrical connector contacts the negative terminal and the moveable portion presses the first portion of the at least one electrical connector against the positive terminal and the second portion of the at least one electrical connector the negative terminal to form a circuit.

A further aspect of the invention is a battery housing including: a fuel cell compartment; a positive terminal site; a negative terminal site; a space for a mechanical resistance generator; at least one aperture for receiving at least one electrical connector; and a space for receiving a moveable portion coupled to the aperture which the mechanical resistance generator presses against the at least one electrical connector against the positive terminal and the negative terminal to form a circuit, and the positive and negative terminals are situated within the at least one aperture.

In another aspect of the invention, a wearable garment includes: a connection for an electronic device; at least one electrically conductive connector; and a battery capable of being coupled to the electrically conductive connector to provide power to the connection for an electronic device. The battery includes: a fuel cell; a positive terminal; a negative terminal; a mechanical resistance generator; at least one aperture for receiving the at least one electrically conductive cord connector; and a moveable portion coupled to the aperture which the mechanical resistance generator presses against the at least one electrical connector against the positive terminal and the negative terminal to form a circuit.

In one embodiment, the battery can be moved such that its position along the electrically conductive cord may be altered.

In another embodiment, the electrically conducive connector is an insulated conductive fabric cord or electrically conductive webbing. In another embodiment, the at least one connection for an electronic device is electrically connected to an electrical device.

In another embodiment, the at least one electrical cord connector includes at least two portions which can be individually pressed against the positive and negative terminals by the mechanical resistance generator to form at least two circuits.

In one embodiment, an electrical connection between the electrical device and the battery passes through a fabric interconnect within the wearable device.

In one embodiment, the electrically conductive connector and battery are a mechanism for reducing the diameter of an aperture of said wearable garment.

In another embodiment, the battery can be removed from the wearable garment.

In one aspect of the invention, a method for supplying power to an electronic device includes several steps. One step is providing at least one electrically conductive connector. Another step is providing at least one position on the electrically conductive connector for supplying power to a device when connected to a battery. Another step is electrically and mechanically connecting a battery to the at least one position on said electrically conductive connector to supply power to said electronic device. The battery in the method includes: a fuel cell; a positive terminal; a negative terminal; a housing; a mechanical resistance generator; at least one aperture for receiving at least one electrical connector; and a moveable portion coupled to the aperture which the mechanical resistance generator presses against the at least one electrical cord connector against the positive terminal and the negative terminal to form a circuit, where the positive and negative terminals are situated within the at least one aperture.

The invention provides many additional advantages that are evident from the description, drawings, and claims.

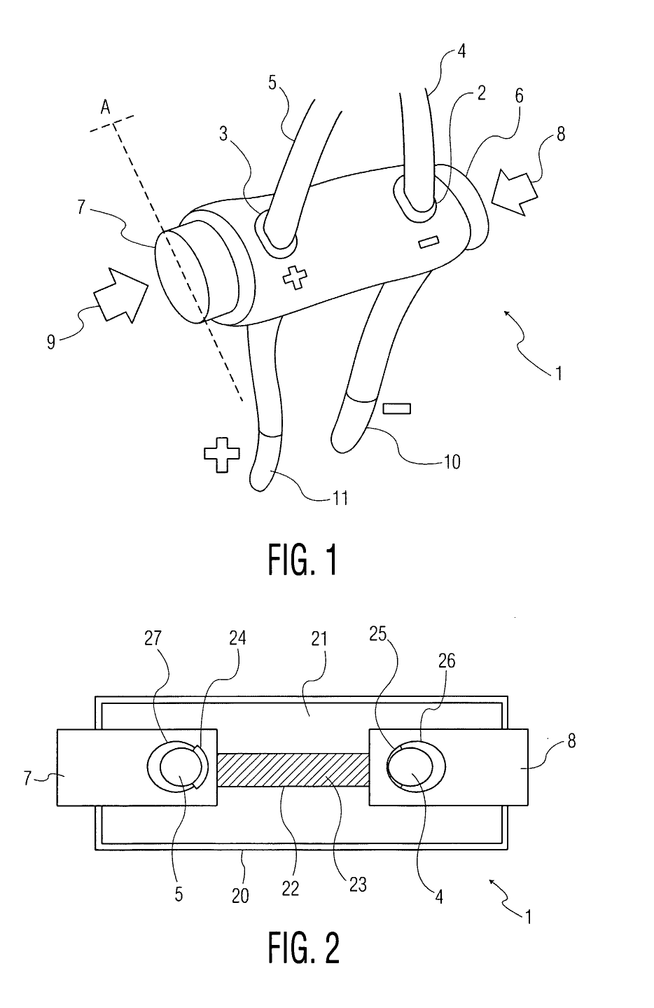

FIG. 1 depicts an exemplary battery with two apertures employing two electrical connectors;

FIG. 2 depicts a cross section of the battery in FIG. 1 through the plane crossed by line A;

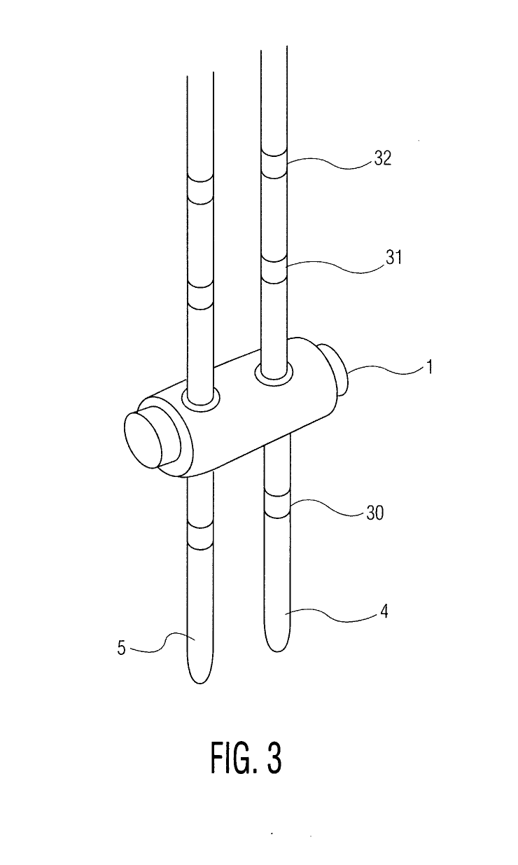

FIG. 3 depicts a pair of electrical connectors with multiple circuit positions on which the battery can be placed;

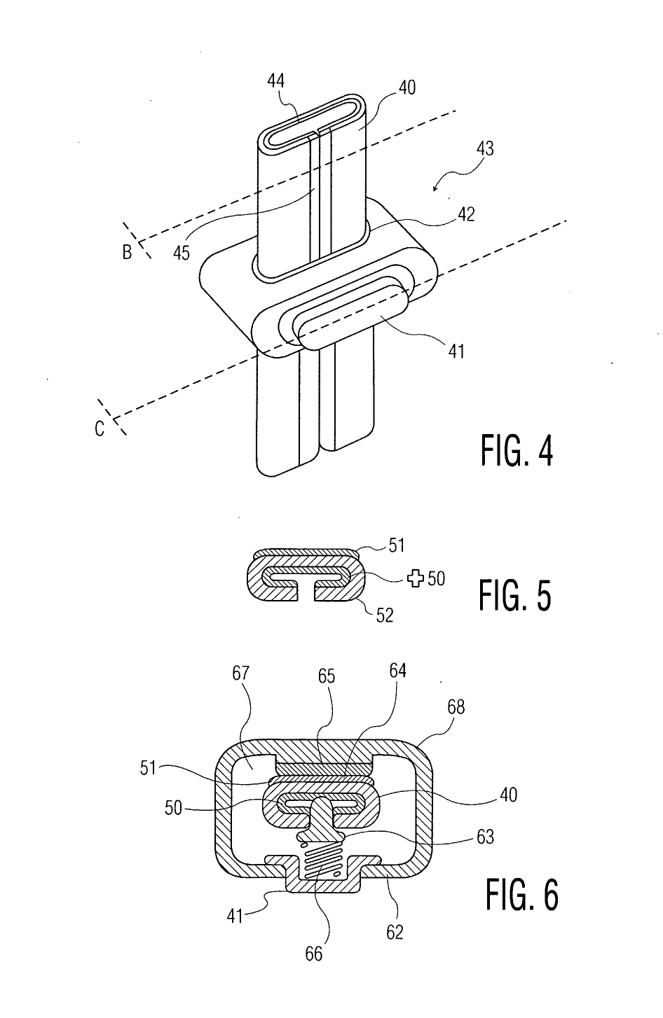

FIG. 4 depicts an exemplary battery with a single aperture employing one electrical connector;

FIG. 5 depicts a cross section of the electrical connector in FIG. 4 through the plane crossed by line B;

FIG. 6 depicts a cross section of the battery in FIG. 4 through the plane crossed by line C;

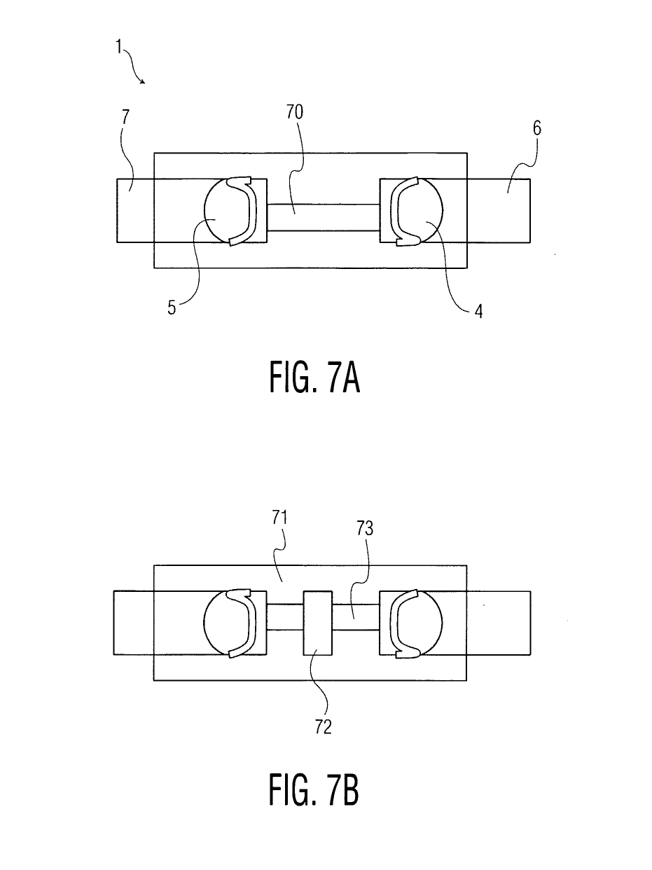

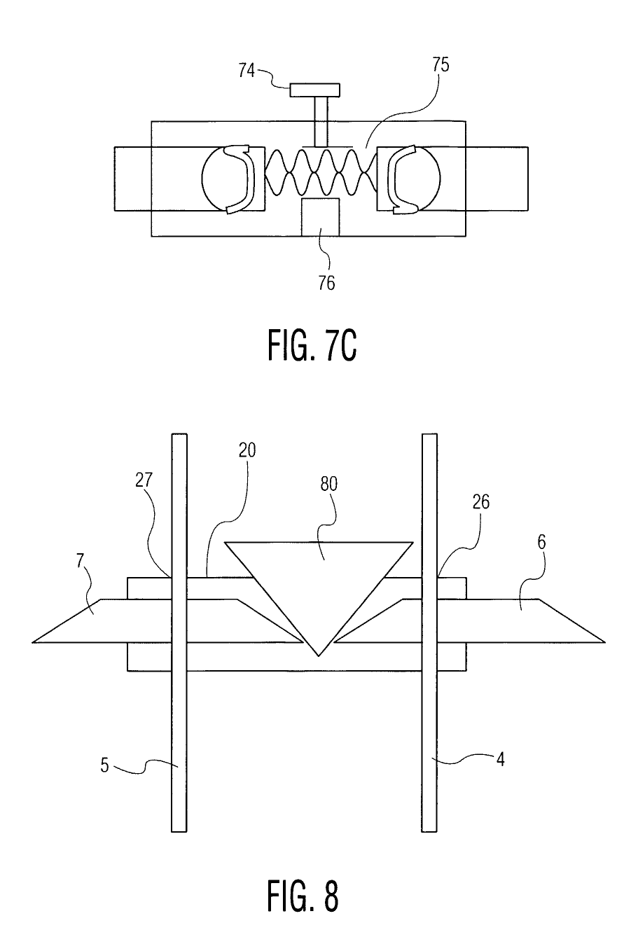

FIG. 7A depicts a depicts a cross section of the battery in FIG. 1 through the plane crossed by line A which includes an elastic material mechanical resistance generator;

FIG. 7B depicts a cross section of the battery in FIG. 1 through the plane crossed by line A which includes a pneumatic mechanical resistance generator;

FIG. 7C depicts a cross section of the battery in FIG. 1 through the plane crossed by line A which includes a screw-type mechanical resistance generator;

FIG. 8 depicts a cross section of the battery in FIG. 1 through the plane perpendicular to line A which includes a wedge-type mechanical resistance generator;

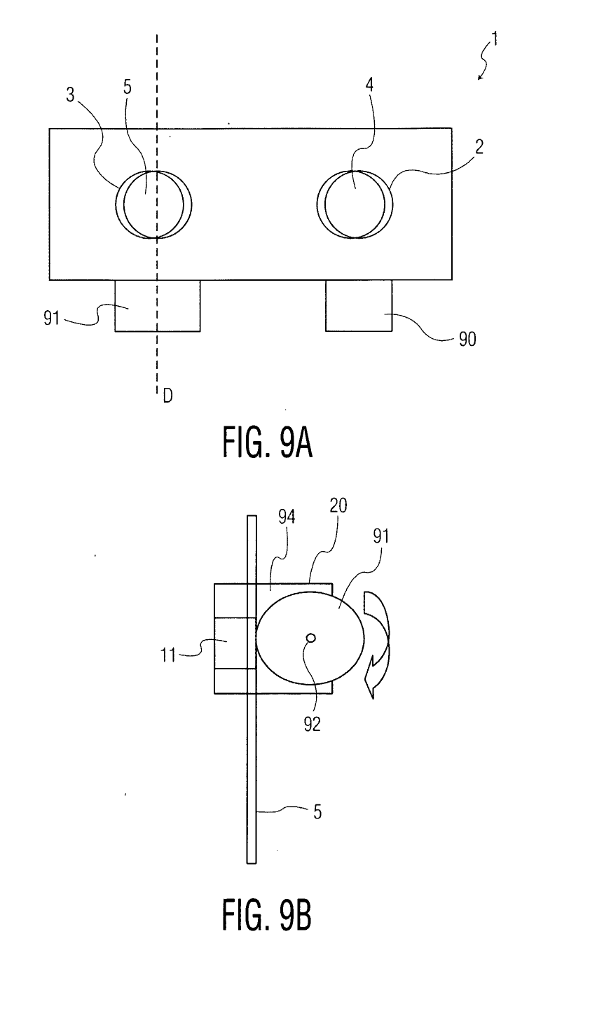

FIG. 9A depicts a top view of a battery with two apertures employing two electrical connectors and two wheels for moving the position of the battery on the electrical connectors;

FIG. 9B depicts a cross-section view of the battery of FIG. 9a in the plane of line D;

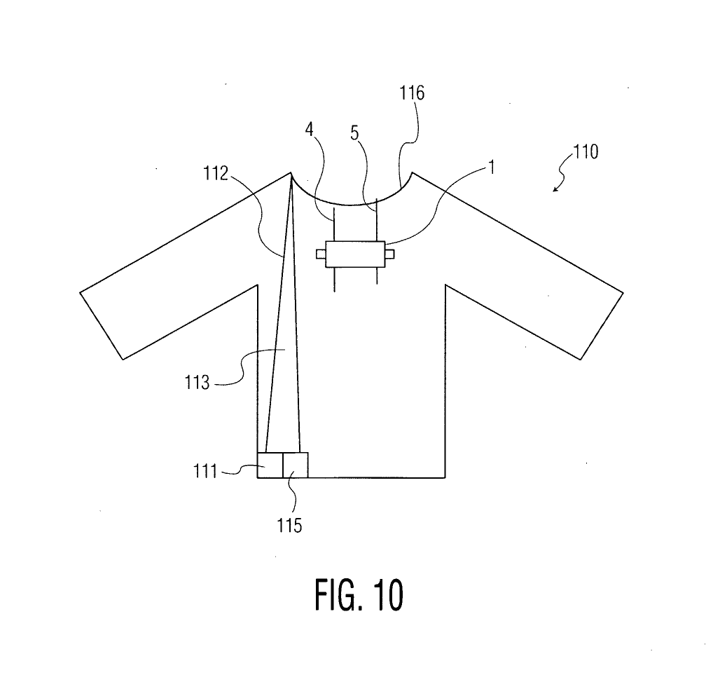

FIG. 10 depicts a wearable garment including a battery, electrical connectors, and a connection for a portable electronic device.

FIG. 1 depicts a battery 1 with two apertures 2, 3 for receiving electrical connectors 4 and 5. Electrical connectors 4, 5 can be formed from insulated conductive fabric cord, non-insulated conductive fabric cord, electrically conducive webbing, or any other known material suitable for wearable electronic applications.

Battery I also has two moveable portions 6 and 7 that are, for example, pistons. Moveable portions 6 and 7 can be depressed along arrows 8 and 9. When depressed, holes (not shown) in moveable portions 7 and 8 align with apertures 3 and 2, respectively. This allows the position of the battery 1 along the electrical connectors 4, 5 to be altered. Electrical connectors 4, 5 can be formed of, for example, an insulated conductive fabric cord or electrically conductive webbing. Additionally, electrical connectors 4, 5 contain segments 10, 11 corresponding to a negative contact and a positive contact, respectively. Moveable portions 8 and 9 contain a negative terminal and a positive terminal, respectively. When battery 1 is positioned such that segments 10, 11 are with apertures 2 and 3, respectively, a circuit is formed and current passes from battery I through electrical connectors 4 and 5 to power a portable device.

FIG. 2 depicts a cross section of the battery in FIG. 1 through the plane parallel to line A. Electrical connectors 4, 5 pass through holes 26, 27 in moveable portions 6, 7. Mechanical resistance generator 23, for example a spring, provides mechanical force against moveable portions 6, 7 such that an edge in each of holes 26, 27 presses against electrical connectors 4, 5. This mechanical force also provides sufficient frictional force between the edges of holes 26, 27 and electrical connectors 4, 5 such that battery 1 overcomes the force of gravity and electrical connectors 4, 5 can support at least the weight of battery 1.

Additionally, The edge in hole 26 either contains negative terminal 25 or supports it. The edge in hole 27 either contains positive terminal 24 or supports it. When pressure is applied to moveable portions 7 and 8, mechanical resistance generator 23 compresses. This may break electrical contact between positive terminal 24 and electrical connector 5. This also may break electrical contact between negative terminal 25 and electrical connector 4. Further, the compression of mechanical resistance generator 23 overcomes the frictional force caused by the edge of holes 26, 27 pressing against electrical connectors 4, 5 and allows battery 1 to alter positions along the length of electrical connectors 4, 5. Additionally, battery 1 can be removed entirely from electrical connectors 4, 5 and placed in a recharging station (not shown).

Fuel cell compartment 21 contains a power source, such as an electrochemical cell of NiCd, or ZnHg. To protect moveable portions 6, 7 and mechanical resistance generator 23 from degradation caused by the power source, each can be compartmentalized within the battery housing 20. Additionally, each can also be coated to protect their contents from degradation.

FIG. 3 depicts a pair of electrical connectors 4, 5 with multiple circuit positions 30, 31, 32 on which the battery 1 can be placed. Circuit positions 30, 31, 32 can correspond to different devices or functionalities of a single device such that when battery 1 is placed, for example, on circuit position 30, it will power a cellular telephone, and when it is placed on circuit position 31 it will power a portable MP3 player. Electrical connectors 4, 5 are not insulated over circuit positions 30, 31, and 32 and they have only a number of conductive small areas on their surface.

FIG. 4 depicts a battery 43 with a single aperture 42 that receives one electrical connector 40. Battery 43 includes a single moveable portion 41, for example a screw. Electrical connector 40 also includes a track 44. Within an inner portion of track 44 is a positive terminal. An outer portion of track 44 either contains or supports a negative terminal. When battery 42 is positioned such a conductive segment is with aperture 42, a circuit is formed and current passes from battery 42 through electrical connector 40 to power a portable device. Moveable portion 41 activates a mechanical resistance generator to press a positive first portion 50 of the electrical connector 40 against the positive terminal and a second portion 51 of electrical connector 40 against the negative terminal to form a circuit. The positive first portion 50 and negative second portion 51 are shown in FIG. 5 as being supported by an insulator 52. Additionally moveable portion 41 can be unscrewed to allow the position of the battery 43 along the electrical connector 40 to be altered.

FIG. 6 depicts a cross section of battery 43 in FIG. 4 through the plane parallel to line C. Electrical connector 40 passes through hole 42 in battery housing 62. An alignment mechanism 63 aligns electrical connector 40 such that positive first portion 50 and negative second portion 51 contact positive terminal 64 and negative terminal 65. Positive terminal 64 is either contained within or supported by alignment mechanism 63. Negative terminal 65 is either contained within or supported by battery housing 62. Mechanical resistance generator 66, for example a screw, can be manipulated by moveable portion 41 to apply or release mechanical force on alignment mechanism 63. This mechanical force provides sufficient frictional force between alignment mechanism 63, electrical connector 40, and negative terminal 65 such that battery 43 overcomes the force of gravity and electrical connector 40 can support at least the weight of battery 43.

Additionally, when force is applied to alignment mechanism 63 by mechanical resistance generator 66, this can create an electrical contact between positive terminal 64 and positive first portion 50 of electrical connector 40, and negative terminal 65 and negative second portion 51 of electrical connector 40. A reduction in the force generated by mechanical resistance generator 66 may break electrical contact between positive terminal 64 and positive first portion 50 of electrical connector 40, and negative terminal 65 and negative second portion 51 of electrical connector 40. Further, a reduction in the force generated by mechanical resistance generator 66 allows battery 43 to alter its positions along the length of electrical connector 40. Additionally, battery 43 can be removed entirely from electrical connector 40 and placed in a recharging station (not shown).

Fuel cell compartment 67 contains a power source, such as an electrochemical cell of NiCd, or ZnHg. To protect moveable portions 41, mechanical resistance generator 66, alignment mechanism 63, and electrical connector 40 from degradation caused by the power source, each can be compartmentalized within the battery housing 68. Additionally, each can also be coated to protect their contents from degradation.

FIGS. 7A-7C depict a cross section of the battery 1 in FIG. 1 through the plane crossed by line A containing various mechanical resistance generators 23. In FIG. 7A, the mechanical resistance generator 70 is formed of an elastic material which provides an elastic force against moveable portions 6, 7. In FIG. 7B, mechanical resistance generator is a pneumatic device 71 which utilizes a gas contained within chamber 72 to push against pistons 73 and generate force against moveable portions 6, 7. In FIG. 7C, the mechanical resistance generator 70 is formed of a screw 74 which, when turned, applies force against a coil 75 that elongates when pressed between screw 74 and block 76 to provide force against moveable portions 6, 7.

FIG. 8 depicts a cross section of the battery 1 in FIG. 1 through the plane perpendicular to line A. Battery 1 includes a wedge-type mechanical resistance generator 80 that extends beyond battery housing 20. Wedge-type mechanical resistance generator 80 is capable of being depressed such that it forces moveable portions 6 and 7 apart. This force against moveable portions 6, 7 can cause an edge in each of holes 26, 27 to press against electrical connectors 4, 5. This mechanical force also provides sufficient frictional force between the edges of holes 26, 27 and electrical connectors 4, 5 such that battery 1 overcomes the force of gravity and electrical connectors 4, 5 can support at least the weight of battery 1. Pulling up on wedge-type mechanical resistance generator 80 can break the circuit, move battery 1 along electrical connectors 4, 5, or remove battery I from electrical connectors 4, 5, can reduce the force.

FIG. 9A depicts a top-view of battery 1 with two apertures 2, 3 employing two electrical connectors 4, 5 and two wheels 90, 91 for forming an electrical contact between the battery and for altering the position of battery I on the electrical connector 4, 5. FIG. 9B depicts a cross-section view of battery 1 of FIG. 9A in a plane parallel to line D. Wheel 91 is attached to battery housing 20, for example, by an axle 92 which can be mounted on a mechanical resistance generator, such as a spring. Wheel 91 can be rotated in either direction. A mechanical resistance generator (not shown) provides sufficient force to enable the rotation of wheel 91 to cause battery 1 to alter its position along electrical connector 5. In this case, rotating wheel 91 clockwise will cause battery 1 to descent along electrical connector 5. Rotating wheel 91 counter-clockwise will cause battery 1 to ascend along electrical connector 5. Additionally, the mechanical resistance generator causes wheel 91 to press electrical connector 5 against terminal 93. When battery 1 either ascends or descends to a conductive segment 11 on electrical connector 5, force against electrical connector 5 from the mechanical resistance generator causes conductive segment 11 to contact terminal 93 and form at least a part of a circuit. Additionally, the mechanical force also provides sufficient frictional force between wheel 91, electrical connector 5, and terminal 93 that battery 1 overcomes the force of gravity and electrical connector 5 can support at least a portion of the weight of battery 1. Wheel 91 can also be designed to lock into place when it is desired that batter 1 not be moved.

Fuel cell compartment 94 contains a power source, such as an electrochemical cell of NiCd, or ZnHg. To protect wheel 91, and its mechanical resistance generator from degradation caused by the power source, each can be compartmentalized within the battery housing 20. Additionally, each can also be coated to protect their contents from degradation.

FIG. 10 depicts a wearable garment 110 including a battery 1, electrical connectors 4, 5, and at least one connection for an electronic device 111, 115. Electrical connectors 4 and 5 both support battery 1, but also are used to control the aperture width of the collar 116 of garment 110. Electrical connectors, such as 4 and 5 can be used to control any width of any aperture of a garment such as garment 110. Garment 110 also includes fabric interconnects 112 and 113 which connect electrical connectors 4, 5 to connections for an electronic device 111, 115, respectively. Fabric interconnects any known fabric interconnect.

Electrical connectors can have multiple circuit portions as shown in FIG. 3 and its accompanying description. In FIG. 10, different circuit positions can correspond to different connections for an electronic device 111, 115 such that when battery 1 is placed, for example, on a first circuit position, it will power a connection 111, and when it is placed on a second position it will power connections 115.

Battery 1 can be removed from garment 110 by depressing the moveable portions and sliding battery 1 off of electrical connectors 4, 5. Additionally, battery I can be used to power any type of electrical device.

The preceding expressions and examples are exemplary and are not intended to limit the scope of the claims that follow.

What is claimed is:

1. A battery (1) comprising:
a fuel cell (21);
a positive terminal (24);
a negative terminal (25);
a housing (20);
a mechanical resistance generator (23);
at least one aperture (26) for receiving at least one electrical connector (4); and
a moveable portion (8) coupled to the housing (20) which the mechanical resistance generator (23) presses against the at least one electrical connector (4) against the positive terminal (24) and the negative terminal (25) to form a circuit.

2. The battery (1) of claim 1, wherein the mechanical resistance generator (23) comprises a spring, an elastic material, a pneumatic device, a screw, or a wedge.

3. The battery (1) of claim 1, wherein the moveable portion (8) comprises a piston, a wheel, a button, or a screw.

4. The battery (1) of claim 1, wherein the battery (1) further comprises a first aperture (27) for receiving a first electrical connector (5) and a second aperture (26) for receiving a second electrical conductor (4), and wherein the first aperture (27) contains the positive terminal (24) and the second aperture (26) contains the negative terminal (25).

5. The battery (1) of claim 4, wherein the mechanical resistance generator (23) presses a first moveable portion (7) against an electrical conductor in the first aperture (27) which forms an electrical connection with the positive terminal (24) and a second moveable portion (8) against a second electrical conductor in the second aperture (26) which forms and electrical connection with the negative terminal (25) to form a circuit.

6. The battery (1) of claim 1, wherein the at least one electrical conductor (4) further comprises an electrically conductive cord.

7. The battery (1) of claim 6, wherein the mechanical resistance generator (23) provides sufficient frictional force by pressing the moveable portion (8) against the electrically conductive cord (4) to overcome the force of gravity such that the electrically conductive cord (4) will support at least a portion of the weight of the battery (1).

8. The battery of claim 7, wherein the moveable portion can be moved such that position of the battery along the electrically conductive cord may be altered.

9. The battery (1) of claim 6, wherein the electrically conducive cord is an insulated conductive fabric cord.

10. The battery (1) of claim 1, wherein the at least one electrical connector (4) is electrically connected to an electrical device.

11. The battery (1) of claim 1, wherein the at least one electrical connector (4) further comprises at least two portions (30, 31) which can be individually pressed against the positive (24) or negative terminals (25) by the mechanical resistance generator (23) to form at least two circuits.

12. The battery (1) of claim 10, wherein an electrical connection between the electrical device and the battery (1) passes through a wearable device.

13. The battery (1) of claim 1, wherein the at least one aperture (42) further comprises both the positive terminal (64) and the negative terminal (65) and wherein a first portion (50) of the at least one electrical connector (40) contacts the positive terminal (64) and a second portion (51) of the at least one electrical connector (40) contacts the negative terminal (65) and wherein the moveable portion (63) presses the first portion (50) of the at least one electrical connector (40) against the positive terminal (64) and the second portion (51) of the at least one electrical connector (40) against the negative terminal (65) to form a circuit.

14. A battery housing (20) comprising:
a fuel cell compartment (21);
a positive terminal site (24);
a negative terminal site (25);
a space for a mechanical resistance generator (22);
at least one aperture for receiving at least one electrical connector (26, 27); and
a space for receiving a moveable portion (7, 8) coupled to the housing (20) which the mechanical resistance generator (23) presses against the at least one electrical connector (4, 5) against the positive terminal (24) and the negative terminal (25) to form a circuit.

15. A wearable garment (110) comprising:
a connection (111) for an electronic device;
at least one electrically conductive connector (4, 5); and
a battery (1) capable of being coupled to the electrically conductive connector (4, 5) to provide power to the connection (111) for an electronic device, said battery (1) comprising:
a fuel cell (21);
a positive terminal (24);
a negative terminal (25);
a mechanical resistance generator (23);
at least one aperture (26, 27) for receiving the at least one electrically conductive connector (4, 5); and
a moveable portion (7, 8) coupled to the battery (1) which the mechanical resistance generator (23) presses against the at least one electrically conductive connector (4, 5) against the positive terminal (24) and the negative terminal (25) to form a circuit.

16. The wearable garment (110) of claim 15, wherein the battery (1) can be moved such that its position along the at least one electrically conductive connector (4, 5) may be altered.

17. The wearable garment (110) of claim 15, wherein the at least one electrically conducive connector (4, 5) is an insulated conductive fabric cord or electrically conductive webbing.

18. The wearable garment (110) of claim 15, wherein the at least one connection (111) for an electronic device is electrically connected to an electrical device.

19. The wearable garment (110) of claim 15, wherein the at least one electrically conductive connector (4, 5) further comprises at least two portions (30, 31) which can be individually pressed against the positive (24) and negative (25) terminals by the mechanical resistance generator (23) to form at least two circuits.

20. The wearable garment (110) of claim 15, wherein an electrical connection between the electrical device and the battery (1) passes through a fabric interconnect (112) within the wearable garment.

21. The wearable garment (110) of claim 15, wherein the at least one electrically conductive connector (4, 5) and battery (1) further comprise a mechanism for reducing the diameter of an aperture (116) of said wearable garment (110).

22. The wearable garment (110) of claim 15, wherein the battery (1) can be removed from the wearable garment (110).

23. A method for supplying power to an electronic device comprising:
providing at least one electrically conductive connector (4, 5);
providing at least one position (30, 31) on said electrically conductive connector (4, 5) for supplying power to a device when connected to a battery (1);
electrically and mechanically connecting a battery (1) to said at least one position (30, 31) on said at least one electrically conductive connector (4, 5) to supply power to said electronic device, wherein said battery comprises:
a fuel cell (2 1);
a positive terminal (24);
a negative terminal (25);
a housing (20);
a mechanical resistance generator (23);
at least one aperture for receiving at least one electrical connector (26, 27); and
a moveable portion (7, 8) coupled to the at least one aperture (26, 27) which the mechanical resistance generator (23) presses against the at least one electrical cord connector (4, 5) against the positive terminal (24) and the negative terminal (25) to form a circuit, wherein the positive (24) and negative (25) terminals are situated within the at least one aperture (26, 27).
